(19) United States
(12) Patent Application Publication
(10) Pub. No.: US 2026/0359630 A1
(43) Pub. Date: Nov. 12, 2026

(54) MEMORY-SCALABLE SYSTEM AND METHOD BASED ON FINE-GRAINED STATIC COMPUTATION GRAPHS

(71) Applicant: HUAZHONG UNIVERSITY OF SCIENCE AND TECHNOLOGY, Wuhan (CN)

(72) Inventors: Xuanhua SHI, Wuhan (CN); Hai JIN, Wuhan (CN); Xuan PENG, Wuhan (CN); Haolin ZHANG, Wuhan (CN); Weifang HU, Wuhan (CN); Yunfei ZHAO, Wuhan (CN)

(21) Appl. No.: 19/665,719

(22) Filed: May 1, 2026

(30) Foreign Application Priority Data
May 7, 2025 (CN) 2025105842146
Apr. 9, 2026 (CN) 2026104598163

(51) Int. Cl. G06N 3/08

(52) U.S. Cl. CPC G06N 3/08

(57) ABSTRACT

A memory-scalable system based on fine-grained static computation graphs includes a structural unit, a model planning unit, and an optimization unit. The structural unit parses a neural network model structure into a fine-grained static computation graph with computation nodes as basic units, obtaining training state information. The model planning unit calculates a computation-balanced partition point and a memory-balanced partition point for stage nodes based on the graph and information, and enumerates computation nodes within a closed interval defined by both points to determine an optimal partition point for partitioning the model into sub-computation graphs until a target number of stages is reached. The optimization unit evaluates overhead costs of applying memory swapping and recomputation technologies based on a cost model after model partitioning to select a GPU memory optimization scheme.

### BACKGROUND OF THE APPLICATION

This application claims the benefit of China Patent Application No. 2025105842146, filed on May 7, 2025, and this application claims the benefit of China Patent Application No. 2026104598163, filed on Apr. 9, 2026 which are incorporated by reference herein in its entirety.

### 1. TECHNICAL FIELD

The present disclosure relates to the technical fields of computer distributed training and artificial intelligence, and more particularly, to a memory-scalable system and method based on fine-grained static computation graphs.

### 2. DESCRIPTION OF RELATED ART

Deep Neural Networks (DNNs) have achieved significant progress in fields such as computer vision, autonomous driving, and natural language processing. The performance improvements of these networks are highly dependent on the optimization of model architectures and the continuous scaling of parameter sizes. However, as the number of model parameters grows exponentially, the increase in GPU memory capacity lags far behind the growing demand, leading to memory bottlenecks in large-scale model training. To overcome this limitation, distributed training technologies across multiple GPUs have gradually become a core research focus in both academia and industry. Typical methods include Data Parallelism (DP), Tensor Parallelism (TP), and Pipeline Parallelism (PP).

DP replicates model parameters across multiple GPUs and distributes different data subsets for computation, ultimately updating parameters through gradient aggregation. However, its communication overhead grows quadratically with increasing model scale, leading to decreased efficiency. TP partitions the computation tasks of a single node across multiple GPUs, thereby reducing the memory load on a single device, but its heavy reliance on high-bandwidth communication significantly limits its scalability. In contrast, PP partitions the model by layers into multiple stages and splits an input batch into micro-batches, utilizing a pipeline scheduling mechanism to pass intermediate results between adjacent stages. PP offers the advantages of low communication volume and low bandwidth requirements, making it a key technology for large-scale model training.

Current PP frameworks are primarily categorized into Synchronous Pipeline Parallelism (SPP) and Asynchronous Pipeline Parallelism (APP). SPP (e.g., GPipe) ensures parameter consistency through global synchronization, but stage synchronization leads to pipeline bubbles and underutilization of GPUs. APP (e.g., PipeDream) utilizes a 1F1B scheduling strategy to eliminate bubbles. However, it requires maintaining multiple versions of parameter replicas to resolve conflicts between forward and backward computations, leading to a significant increase in memory footprint in earlier stages. Both methods are required to balance the computation time of each stage to prevent lagging stages from affecting overall efficiency. However, existing PP frameworks still face severe memory imbalances and local memory bottlenecks when dealing with ultra-large-scale models. Experiments have shown that existing frameworks lead to significant GPU memory waste due to the following issues: 1) marked differences in the ratio of computation time to memory footprint across different layer types (e.g., the heterogeneity of fully connected layers vs. attention layers); 2) inconsistencies in the number of parameter versions, activation memory, and gradient requirements across stages, further exacerbating memory imbalance. These issues severely limit the memory scalability of PP and hinder the training of even larger-scale models.

To alleviate memory pressure, single-device optimizations such as memory swapping and recomputation have been proposed in the industry. However, in complex multi-device distributed pipeline scheduling environments, simply introducing these technologies often leads to high overhead, such as frequent data movement latency and repeated computation costs, which delays the training timeline. How to achieve continuous flow of parallel stages, global balanced memory utilization, and improved overall throughput under memory constraints remains a critical technical challenge in the field of large-scale artificial intelligence training.

For example, CN113792848A discloses a memory optimization method for pipeline model parallel training based on feature map encoding. The steps include: constructing a pipeline DNN model training scheme, employing an asynchronous parameter update method, and concurrently executing training for different batches; recording the forward and backward pass processes completed by the training batches within a unit pipeline execution time; during the model training process, encoding generated feature maps after the forward computation tasks are completed to store them in a low-memory-footprint format, thereby reducing the memory footprint required for feature map storage; and during backward computation, decoding the stored feature maps to restore high-precision original data, thereby achieving memory optimization for pipeline parallel training based on feature map encoding. The flaws of this technical solution are mainly reflected in computation efficiency, dynamic optimization capability, and systematic theoretical support. On one hand, this process—which involves encoding and compressing the generated feature maps upon completion of the forward pass, and then decoding and restoring them during the backpropagation stage—reduces the memory footprint for feature map storage but introduces additional computation overhead for encoding and decoding. Especially when processing high-resolution feature maps, the algorithmic complexity increases significantly, which may lead to delays in the training timeline of pipeline parallel training, partially offsetting the performance gains from memory optimization. On the other hand, the technical solution employs a static storage strategy with fixed encoding formats, lacking a dynamic response mechanism to real-time GPU memory pressure. Its memory optimization is only implemented through preset compression rules and cannot dynamically adjust based on actual resource consumption during training.

Already-existing PP and memory optimization schemes expose several underlying technical defects when dealing with complex models and extreme GPU memory limits.

For example, CN109919310A discloses a GPU memory optimization method for deep learning training tasks. This solution relies on collecting runtime data to establish an overall performance model for swap-in/swap-out strategies and determines the optimal micro-batch size based on it. However, this method, which relies on coarse-grained micro-batch level modeling, fails to penetrate the model's internal structure to obtain micro-states at the computation node level when dealing with complex models. Due to its lack of static structural parsing of the fine-grained computation graph, fine-grained states—such as precise forward durations, backward durations, and single-tensor GPU memory footprints during model runtime—remain invisible, making it difficult to support higher-precision concurrent scheduling at the underlying level.

For example, CN115543639A discloses an optimization method for distributed execution of deep learning tasks. This technical solution primarily generates candidate partitioning schemes by pre-setting physical groupings of hardware resources and performs overhead screening. However, this planning method, which depends on coarse hardware grouping, lacks a rigorous enumeration and optimization search mechanism based on the physical topology closed interval of computation nodes when performing model space search and stage partitioning. Furthermore, for partitioning involving a non-power-of-two number of stages (e.g., an odd number), it lacks an asymmetric allocation strategy and spatial offset logic based on remaining nodes, which easily leads to imbalanced mapping issues for computation nodes after partitioning.

For example, CN114746871A discloses a scheduling technology based on timing relaxation of computation tensors and the establishment of a runtime static graph. When screening tensors for offloading, this technical solution primarily relies on heuristic rules such as descending order of tensor size and timing slack. However, in a memory-constrained state where multi-device pipeline parallelism faces imminent GPU memory overflow, such scheduling—based purely on the ranking of heuristic metrics—lacks hardware-level intervention and fault-tolerance mechanisms, thus still posing a risk of resource exhaustion. Furthermore, its scheduling strategy does not perform high-precision unified mathematical quantification of the overhead costs for memory swapping and recomputation technologies; it lacks compensatory protection and adaptive convergence capabilities in states where recomputation time is extremely short, making it difficult to achieve optimal collaborative coordination under resource constraints.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

To address the deficiencies of the existing art, from a first aspect, the present disclosure provides a memory-scalable system based on fine-grained static computation graphs, the system comprising: a structural unit, a model planning unit, and an optimization unit. The structural unit is configured to parse the structure of a neural network model into a fine-grained static computation graph with computation nodes as basic units, and obtain training state information of the neural network model. The model planning unit is configured to calculate a computation-balanced partition point and a memory-balanced partition point for stage nodes based on the fine-grained static computation graph and the training state information, enumerate computation nodes within a closed interval defined by the computation-balanced partition point and the memory-balanced partition point to determine an optimal partition point for partitioning the neural network model into left and right sub-computation graphs, and process until a target number of stages is reached. The optimization unit is configured to evaluate the overhead costs of applying memory swapping and recomputation technologies based on a cost model after model partitioning is completed, so as to select a GPU memory optimization scheme.

The technical solution of the present disclosure overcomes the deficiencies of common layer-based or coarse-grained micro-batch partitioning, where the partitioning granularity is too coarse, by extending the model profiling granularity down to the computation node level to accurately obtain the runtime duration and GPU memory tensor residency of individual computation nodes. Simultaneously, the present disclosure anchors the computation-balanced partition point and the memory-balanced partition point into a physical topology closed interval, such that the subsequent search for the optimal partition point is restricted within the dual constraint boundaries of computing power and GPU memory, effectively avoiding the local-stage GPU memory overflow caused by partitioning based on a single dimension.

According to a preferred embodiment, the step performed by the structural unit to parse the structure of the neural network model into a fine-grained static computation graph with computation nodes as basic units includes: parsing the structure of the neural network model into a fine-grained static computation graph based on deep learning compilation technology; and if the neural network model contains a dynamic control flow, additionally wrapping the dynamic control flow via a wrapper function to construct the fine-grained static computation graph.

The present disclosure solves the technical challenge in deep learning models where branch conditions change dynamically with inputs, leading to fragmented static graph parsing or loss of network topology. By wrapping dynamic execution flows into a single static super-node with deterministic GPU memory and timing expectations via a wrapper function, the structural integrity of the fine-grained static computation graph is guaranteed during the parsing of complex heterogeneous models, thereby providing a coherent graph node foundation for subsequent traversal and enumeration.

According to a preferred embodiment, the step performed by the structural unit to obtain the training state information of the neural network model includes: registering customized functions in the forward computation function and the backward computation function of the neural network model, respectively, using hook technology, so as to obtain training state information including forward computation time, backward computation time, and tensor GPU memory footprint of the computation nodes.

The aforementioned technical features eliminate surface-level timing measurement errors caused by the asynchronous execution scheduling mechanism of deep learning frameworks in solving the state acquisition problem. By inserting hardware-level synchronization events before and after the execution of underlying computation nodes, time consumption and GPU memory footprint data are mapped to specific nodes of the fine-grained graph, thereby extracting the actual forward and backward durations executed on physical hardware, as well as the GPU memory lifecycle of individual tensors, which provides accurate spatio-temporal constraint input parameters for the model planning unit.

According to a preferred embodiment, the step performed by the model planning unit to calculate the computation-balanced partition point and the memory-balanced partition point for stage nodes includes: calculating the total computation time of the current pipeline stage, and subsequently deriving the computation-balanced partition point based on the computation time consumption of the stage nodes, and deriving the memory-balanced partition point based on the GPU memory consumption of the stage nodes; wherein the total computation time is the sum of the forward computation times and the backward computation times of all nodes within the computation node set of the current stage.

The present disclosure logically decouples the relationship between temporal evaluation and spatial evaluation. By uniformly accumulating the forward and backward times as the benchmark for evaluating time consumption, the influence of computation nodes on the pipeline execution time span is objectively reflected. Meanwhile, by independently modeling GPU memory consumption to derive the memory-balanced point, the present disclosure quantifies the resource consumption deviation introduced by different types of computation nodes, thereby determining the physical boundaries of the optimization search closed interval within the fine-grained graph.

According to a preferred embodiment, the step performed by the model planning unit to process until the target number of stages is reached specifically includes: selecting an intermediate stage of a pipeline, and treating left and right intervals as independent stages to perform recursive processing layer by layer; when the current number of remaining stages is greater than 3, continuing to perform bisection processing on an interval from a leftmost or rightmost computing device to the intermediate stage; when the current number of remaining stages is equal to 3, executing traversal starting from the computation-balanced partition point and the memory-balanced partition point of the first stage to derive an optimal partition point through enumeration; and when the current number of remaining stages is equal to 2, performing an enumeration search within a closed interval defined by the computation-balanced partition point and the memory-balanced partition point to determine an optimal partition point for partitioning the model into left and right sub-computation graphs. For odd-numbered asymmetric partitioning scenarios where the number of remaining stages is 3, the conditional branch logic overcomes computational node mapping misalignment or hardware allocation limitations easily caused by common equivalent bisection methods when processing an odd number of stages, thereby achieving effective allocation and global topological mapping of a distributed optimization search strategy across a computing device cluster.

According to a preferred embodiment, the step performed by the model planning unit to enumerate computation nodes within the closed interval defined by the computation-balanced partition point and the memory-balanced partition point to determine the optimal partition point includes: enumerating partitioning schemes one by one within the closed interval and verifying whether each scheme complies with the GPU memory limit of the computing device; if a currently enumerated partitioning scheme complies with the GPU memory limit, determining it as the optimal partition point; and if not, moving toward the memory-balanced partition point and re-performing the verification. When the currently enumerated partitioning scheme exceeds the GPU memory limit, an algorithm pointer is set to offset unidirectionally toward the memory-balanced partition point. This unidirectional displacement operation effectively reduces the GPU memory allocation load of the current stage. This feedback mechanism ensures that the partitioning scheme is controlled within the threshold of the single device's physical GPU memory, avoiding memory overflow errors during model deployment.

According to a preferred embodiment, the step performed by the optimization unit to evaluate overhead costs of applying memory swapping and recomputation technologies based on a cost model to select a GPU memory optimization scheme includes: calculating idle time and Memory Saving Per Second (MSPS) based on the cost model to quantitatively evaluate the overhead costs of adopting the memory swapping and recomputation technologies, such that under a premise of satisfying the GPU memory limit of computing devices for a given partitioning strategy, a GPU memory optimization scheme with minimum performance overhead is selected to shorten stage execution time.

Herein, the present disclosure transforms the trigger condition for GPU memory optimization means from common heuristic rules into mathematically quantified indicators. By calculating the Memory Saving Per Second (MSPS), inactive tensors with high optimization value (i.e., those that free up a large amount of GPU memory and require short recomputation time) can be identified and filtered. Combined with the calculation of pipeline idle time, data movement or recomputation operations can effectively utilize computation waiting gaps, thereby shortening stage execution time while complying with the GPU memory limit.

According to a preferred embodiment, when all candidate partitioning schemes within the closed interval exceed the physical GPU memory limit of the computing devices, the model planning unit triggers a GPU memory borrowing strategy to manage a main memory state via an interconnect bus, and performs asynchronous data transfer of inactive tensors at peak computation nodes to offload them to a main memory.

According to a preferred embodiment, the optimization unit internally integrates cost calculation logic, memory swapping control logic, and recomputation dispatch logic. The optimization unit is configured to construct a priority queue based on the Memory Saving Per Second calculated for each node, preferentially issue memory scheduling instructions for inactive tensors with the highest Memory Saving Per Second whose lifecycle span covers current pipeline idle time, and invoke a Direct Memory Access (DMA) engine to execute memory swapping in a non-blocking mode.

A second aspect of the present disclosure provides a memory-scalable method based on fine-grained static computation graphs, comprising: parsing the structure of a neural network model into a fine-grained static computation graph with computation nodes as basic units, and obtaining training state information of the neural network model; calculating a computation-balanced partition point and a memory-balanced partition point for stage nodes based on the fine-grained static computation graph and the training state information, enumerating computation nodes within a closed interval defined by the computation-balanced partition point and the memory-balanced partition point to determine an optimal partition point for partitioning the neural network model into left and right sub-computation graphs, and processing until a target number of stages is reached; and evaluating overhead costs of applying memory swapping and recomputation technologies based on a cost model after model partitioning is completed, so as to select a GPU memory optimization scheme.

This method transforms layer-based model partitioning methods into optimization search methods based on underlying computation nodes. By restricting a partitioning search range within the closed interval defined by the “dual-balanced partition points of computation and memory,” invalid search space is narrowed, such that a final stage partitioning strategy logically accounts for both computing power load and GPU memory limit of the computing devices. Combined with the quantitative evaluation mechanism of the cost model, it effectively prevents unnecessary GPU memory optimization operations from impacting the overall pipeline efficiency.

According to a preferred embodiment, the step of calculating the computation-balanced partition point and the memory-balanced partition point for stage nodes includes: calculating the total computation time of the current pipeline stage, and subsequently deriving the computation-balanced partition point based on the computation time consumption of the stage nodes, and deriving the memory-balanced partition point based on the GPU memory consumption of the stage nodes; wherein the total computation time is the sum of the forward computation times and the backward computation times of all nodes within the computation node set of the current stage.

This method quantifies differences in time and space consumption caused by heterogeneous computation nodes at an algorithmic level by uniformly accumulating forward and backward times and independently modeling the GPU memory dimension. This establishes a clear optimization search boundary for subsequent enumeration of the optimal partition point, effectively alleviating the cluster resource allocation imbalance caused by single-dimensional partitioning criteria.

According to a preferred embodiment, the step of parsing the structure of the neural network model into the fine-grained static computation graph with computation nodes as basic units includes: parsing the structure of the neural network model into the fine-grained static computation graph based on deep learning compilation technology; and if the neural network model contains a dynamic control flow, additionally wrapping the dynamic control flow via a wrapper function to construct the fine-grained static computation graph.

According to a preferred embodiment, the step of obtaining the training state information of the neural network model includes: registering customized functions in the forward computation function and the backward computation function of the neural network model, respectively, using hook technology, so as to obtain training state information including forward computation time, backward computation time, and tensor GPU memory footprint of the computation nodes.

According to a preferred embodiment, the step of determining the optimal partition point to partition the neural network model into left and right sub-computation graphs, and processing until the target number of stages is reached includes: selecting an intermediate stage of a pipeline, and treating left and right intervals as independent stages to perform recursive processing layer by layer; when the current number of remaining stages is greater than 3, continuing to perform bisection processing on an interval from a leftmost or rightmost computing device to the intermediate stage; when the current number of remaining stages is equal to 3, executing traversal starting from the computation-balanced partition point and the memory-balanced partition point of the first stage to derive an optimal partition point through enumeration; and when the current number of remaining stages is equal to 2, performing an enumeration search within a closed interval defined by the computation-balanced partition point and the memory-balanced partition point to determine an optimal partition point for partitioning the model into left and right sub-computation graphs.

According to a preferred embodiment, the step of enumerating computation nodes within the closed interval defined by the computation-balanced partition point and the memory-balanced partition point to determine the optimal partition point includes: enumerating partitioning schemes one by one within the closed interval and verifying whether each scheme complies with the GPU memory limit of the computing device; if a currently enumerated partitioning scheme complies with the GPU memory limit, determining it as the optimal partition point; and if not, moving toward the memory-balanced partition point and re-performing the verification.

According to a preferred embodiment, the step of evaluating overhead costs of applying memory swapping and recomputation technologies based on a cost model to select a GPU memory optimization scheme includes: calculating idle time and Memory Saving Per Second based on the cost model to quantitatively evaluate the overhead costs of adopting the memory swapping and recomputation technologies, such that under a premise of satisfying the GPU memory limit of computing devices for a given partitioning strategy, a GPU memory optimization scheme with minimum performance overhead is selected to shorten stage execution time.

A third aspect of the present disclosure provides a memory-scalable hardware device based on fine-grained static computation graphs, comprising: a structural circuit, a model planning circuit, and an optimization circuit that are communicatively connected to one another via an on-chip high-speed hardware interconnect bus; the structural circuit, the model planning circuit, and the optimization circuit are all configured as dedicated processing circuits, wherein the structural circuit is configured to parse the structure of a neural network model into a fine-grained static computation graph with computation nodes as basic units, and obtain training state information of the neural network model; the model planning circuit is configured to calculate a computation-balanced partition point and a memory-balanced partition point for stage nodes based on the fine-grained static computation graph and the training state information, enumerate computation nodes within a closed interval defined by the computation-balanced partition point and the memory-balanced partition point to determine an optimal partition point for partitioning the neural network model into left and right sub-computation graphs, and process until a target number of stages is reached; and the optimization circuit is configured to evaluate overhead costs of applying memory swapping and recomputation technologies based on a cost model after model partitioning is completed, so as to select a GPU memory optimization scheme.

A fourth aspect of the present disclosure provides a storage medium having a computer program stored thereon that, when executed by a processor, causes the processor to perform the steps of the method of the present disclosure.

A fifth aspect of the present disclosure provides an electronic device, comprising a memory and a processor, wherein the memory has a computer program stored thereon that, when executed by the processor, causes the processor to perform the steps of the method of the present disclosure.

According to a preferred embodiment, the electronic device is a host computer, and the processor is communicatively connected to a plurality of computing devices via a peripheral component interconnect bus to transmit the partitioned sub-computation graphs and the GPU memory optimization scheme to the computing devices for deployment and training.

### BRIEF DESCRIPTION OF THE DRAWINGS

FIG. 1 is a flowchart of a memory-scalable method based on fine-grained static computation graphs provided by the present disclosure;

FIG. 2 is a schematic diagram of a flowchart of a pipeline parallel training method provided by the present disclosure;

FIG. 3 is a schematic diagram of another pipeline parallel training method provided by the present disclosure;

FIG. 4 is a graph of experimental results of a trainable scale for a model provided by the present disclosure;

FIG. 5 is a curve graph of experimental results of training throughput for a GPT-2 model provided by the present disclosure;

FIG. 6 is a curve graph of experimental results of training throughput for a T5 model provided by the present disclosure;

FIG. 7 is a schematic diagram illustrating the logical principles of a memory-scalable system based on fine-grained static computation graphs provided by the present disclosure.

### DETAILED DESCRIPTION OF THE EMBODIMENTS

The present disclosure will be described in detail below with reference to the drawings.

The present disclosure provides explanations for certain terms.

Fine-grained static computation graph: A static structural graph generated by parsing a common layer-based model structure to use computation nodes as basic units by using deep learning compilation technology.

Deep learning compilation technology: A technical process of converting a neural network model constructed using a high-level deep learning framework (such as PyTorch or TensorFlow) into an intermediate representation. In the present disclosure, this technology is used to parse the high-level code logic of a model. Through the tracing or scripting mechanisms of an underlying compiler (e.g., but not limited to, TVM, XLA, or Glow), a tensor-level fine-grained static computation graph containing fine-grained memory profiling data is generated.

Training state information: A set of information including a forward computation time, a backward computation time, and a tensor GPU memory footprint of computation nodes.

Dynamic control flow: An execution flow in a neural network model in which different branching decisions are made based on the dimensions of input tensors. To ensure the correct generation of the fine-grained static computation graph, additional wrapping via a wrapper function is required.

Hook technology: A technology of registering customized functions in the forward and backward computation functions of a model to automatically record and obtain state information, such as the computation time and the GPU memory footprint of nodes, during execution.

Binary recursive model partitioning algorithm (bisection method): An algorithm used to dynamically derive an optimal performance strategy for pipeline parallel partitioning. This algorithm selects an intermediate stage of the pipeline and treats the left and right intervals as independent stages for layer-by-layer recursive processing.

Computation-balanced partition point: A balanced partitioning position calculated based on the computation time consumption of stage nodes in the fine-grained static computation graph.

Memory-balanced partition point: A balanced partitioning position calculated based on the GPU memory consumption of stage nodes in a fine-grained static computation graph.

Optimal partition point: An optimal partitioning position for partitioning a model into left and right sub-computation graphs, calculated by enumerating nodes within a closed interval [ρ_{cb}, ρ_{mb}] defined by the computation-balanced partition point and the memory-balanced partition point.

Target number of stages l: A final target number of stages required for model structure partitioning.

Cost model: A model used to calculate idle time and Memory Saving Per Second (MSPS) to evaluate the costs of memory swapping and recomputation, thereby selecting a scheme with a lower performance overhead. The specific calculation formula for the Memory Saving Per Second is:

$$MSPS = \frac{Memory Saving}{Recomputation Time} .$$

Wrapper Function: A code wrapping mechanism used to handle dynamic control flows in neural networks. When dynamic flows exist in a model where execution branches depend on input tensor dimensions, pure static graph tracing will lead to a loss of execution paths. The wrapper function wraps these dynamic branch code blocks into independent sub-graph computation nodes recognizable by a compiler (e.g., utilizing PyTorch's @torch.jit.script decorator), thereby ensuring that the fine-grained static computation graph can be generated completely and correctly.

1F1B scheduling strategy (One Forward One Backward): A scheduling mechanism used for asynchronous pipeline parallel training. The 1F1B scheduling strategy alternately executes a forward propagation of a micro-batch and a backward propagation of a micro-batch during stable stages of the pipeline to release activation values that are no longer needed after backpropagation from GPU memory as early as possible, thereby effectively reducing the peak GPU memory footprint in the earlier stages and reducing pipeline bubbles.

Memory swapping and recomputation: Two collaborative optimization technologies adopted to alleviate the memory capacity limit of Graphics Processing Units (GPUs). Memory swapping refers to temporarily offloading inactive tensor data from GPU video random access memory (VRAM) to the main memory of a host computer during computation idle periods, and prefetching it back to the VRAM before it is needed for computation. Recomputation refers to discarding some intermediate activation values during forward propagation to save GPU memory, and re-executing forward computation using reserved input tensors to recover these activation values when they are needed for gradient calculation during backpropagation.

GPU memory limit of computing devices: The maximum capacity threshold of available Video Random Access Memory (VRAM) on a single underlying computing device (such as a single GPU) that is actually usable for supporting model computation. In pipeline parallel training, the total GPU memory footprint of tensors—including parameters, forward activations, and backward gradients—generated by all nodes partitioned and allocated to the computing device must be controlled within this limit to avoid out-of-memory (OOM) errors that cause training interruption.

### Embodiment 1

Performance improvements of deep neural networks are highly dependent on the scaling of model parameter sizes; however, the increase in memory capacity of a single device lags far behind the growth in demand, leading to severe GPU memory bottlenecks in large-scale model training. In existing distributed training technologies, synchronous and asynchronous pipeline parallel frameworks often focus purely on balancing the computation time of each stage when partitioning training stages, so as to avoid lagging stages that slow down the overall progress. This common approach ignores the high heterogeneity in the ratio of computation time to memory footprint across different types of computational layers (e.g., a mixed structure of convolutional layers and fully connected layers), and also fails to consider dynamic differences in the number of parameter versions, activation memory, and gradient requirements across stages. Such a mismatch between computation and memory ultimately leads to a waste of more than 40% of the GPU memory, limiting the training of even larger-scale models.

To alleviate the aforementioned memory pressure, existing studies have attempted to introduce optimization technologies such as memory swapping and recomputation. However, when these technologies are deeply integrated with pipeline parallelism, the tight coupling between memory footprint and computation time forms an NP-hard problem with exponential complexity. Limited by algorithmic complexity, existing solutions can usually only perform model partitioning and optimization decisions at coarse-grained levels such as layers or layer blocks, lacking the ability to perform automated joint analysis of fine-grained computation graphs at the computation node or tensor level, which limits the overall optimization potential of the system. Furthermore, some existing GPU memory optimization schemes (e.g., static encoding and compression of feature maps after forward passes) ostensibly lower storage demands but impose significant encoding and decoding computational overhead. When processing high-resolution feature maps, such additional overhead can easily cause timing delays in the pipeline, which not only negates performance gains from GPU memory optimization but also fails to make dynamic responses based on actual resource consumption during the training process due to fixed static strategies.

In view of the numerous aforementioned deficiencies in the existing art, the present disclosure aims to solve the core technical problems of persistent memory usage imbalance and low training throughput in pipeline parallelism for distributed training. The primary goal of the present disclosure is to overcome local stage GPU memory bottlenecks caused by the common approach of focusing solely on computation time and to eliminate global resource fragmentation.

To achieve this, the present disclosure addresses the limitations of the separation between computation partitioning and memory optimization in common pipeline parallelism through technical means. Specifically, the present disclosure fundamentally achieves balanced peak memory footprint across pipeline stages by parsing an underlying neural network structure into a fine-grained static computation graph with computation nodes as basic units, and performing heuristic enumeration and recursive computation within a closed interval defined by the derived computation-balanced partition point and the memory-balanced partition point. On this basis, to minimize performance overhead under GPU memory limits and solve timing delays caused by common GPU memory optimization means, the present disclosure further introduces a cost model mechanism. This mechanism evaluates system idle time and Memory Saving Per Second (MSPS) quantitatively to decide and select a memory swapping and recomputation scheme with minimum cost, thereby significantly improving the overall trainable scale of large-scale models and their concurrent training speed while effectively shortening the execution time of a single stage.

The present disclosure provides a memory-scalable system and method based on fine-grained static computation graphs. The present disclosure further provides a storage medium for storing a computer program implementing the memory-scalable method based on fine-grained static computation graphs. The present disclosure further provides a processor for implementing the memory-scalable system based on fine-grained static computation graphs.

Preferably, the physical hardware of the memory-scalable system based on fine-grained static computation graphs of the present disclosure comprises a processor. Preferably, the processor comprises a structural unit 100, a model planning unit 200, and an optimization unit 300. The structural unit 100 is connected to the model planning unit 200, and the model planning unit 200 is connected to the optimization unit 300.

Preferably, the underlying physical entities of the system of the present disclosure include a host computer (Host Node, including a Central Processing Unit (CPU) and a system main memory (RAM)) and an underlying computing device cluster (e.g., multiple GPUs equipped with independent video random access memory (VRAM)).

The structural unit 100, the model planning unit 200, and the optimization unit 300 are essentially specific software modules or instruction set sequences residing in the RAM of the host computer, which are invoked and executed by the CPU. Preferably, the structural unit 100, the model planning unit 200, and the optimization unit 300 are implemented as application-specific integrated circuits (ASICs) dedicated to the method steps of the present disclosure.

The CPU is electrically connected to the RAM via a high-speed memory bus to instantiate the structural unit 100, the model planning unit 200, and the optimization unit 300. High-bandwidth data interaction is performed among the structural unit 100, the model planning unit 200, and the optimization unit 300 via an internal bus or shared memory space of the CPU. The CPU executing these units is electrically connected to the underlying multiple GPUs via a peripheral component interconnect bus (e.g., a PCIe 4.0 x16 data bus) for bidirectional data communication, to schedule GPU memory and send the partitioned model.

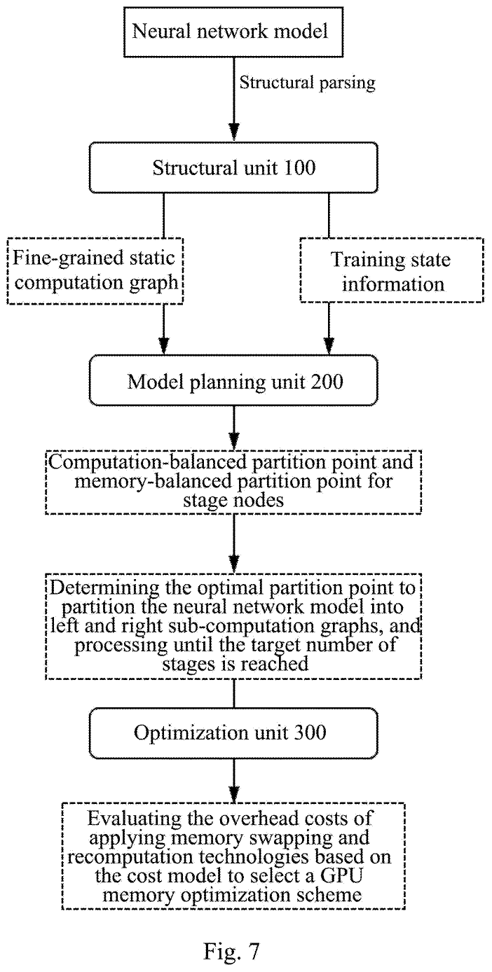

As shown in FIG. 7, the structural unit 100 receives neural network model structure data from a system input interface, performs structural parsing and state acquisition, and obtains a fine-grained static computation graph and training state information. The structural unit 100 sends the fine-grained static computation graph and the training state information to the model planning unit 200.

To address the invisible runtime states and coarse optimization granularity inherent in already-existing solutions—such as the coarse-grained micro-batch performance model-based optimization disclosed in CN109919310A—the present disclosure achieves synergistic optimization of computational and memory resources through a fine-grained architecture. The structural unit 100, serving as a data parsing component of the system, is used to perform fine-grained disassembly of model code and parse internal nested hierarchical states of the graph structure. Specifically, the structural unit 100 is connected to a continuous physical address space of the system main memory by inserting synchronization events at an underlying hardware level; the address space is used to store static graph nodes and branch structure data containing dynamic control flows. The structural unit 100 unidirectionally transmits acquired forward time, backward time, and tensor GPU memory footprint data to the downstream model planning unit 200, providing fine-grained static graph state information for subsequent planning.

The model planning unit 200 receives the fine-grained static computation graph and the training state information from the structural unit 100, and performs partition point calculation and optimal partition point enumeration. As shown in FIG. 7, the model planning unit 200 determines an optimal partition point to partition a neural network model into left and right sub-computation graphs, and processes until the target number of stages is reached. The model planning unit 200 obtains the computation-balanced partition point ρ_{cb}, the memory-balanced partition point ρ_{mb}, and the sub-computation graphs for the stage nodes. The model planning unit 200 sends the computation-balanced partition point ρ_{cb}, the memory-balanced partition point ρ_{mb}, and the sub-computation graphs to the optimization unit 300.

The optimization unit 300 receives the stage partitioning data and the sub-computation graphs from the model planning unit 200, performs calculations for idle time and GPU memory savings, and evaluates optimization schemes, thereby obtaining a GPU memory optimization scheme. Specifically, as shown in FIG. 7, the optimization unit 300 evaluates the overhead costs of applying memory swapping and recomputation technologies based on the cost model to select a GPU memory optimization scheme. The optimization unit 300 sends the GPU memory optimization scheme to the underlying GPUs.

The structural unit 100 is used to perform preliminary structural parsing and data acquisition on the basic structure and runtime state of the neural network model. Specifically, the structural unit 100 operates based on deep learning compilation technology, wherein the fine-grained static computation graph resides in the system main memory in the form of structured data; the data structure of each computation node comprises a unique identifier, a computation node type, input and output tensor shapes, a forward computation time, a backward computation time, and tensor GPU memory footprint indicators. The neural network model is parsed into a fine-grained static computation graph generated with computation nodes as basic units. If the neural network model contains a dynamic control flow, the wrapper function is further employed for wrapping and construction. The wrapper function maps all potential branch logic of the dynamic execution flow into a single static super-node with expected maximum GPU memory and time consumption values, thereby ensuring the correctness of graph generation.

Preferably, the structural unit 100 acquires training state information of the neural network model via hook technology. To eliminate timing measurement errors caused by asynchronous scheduling in deep learning frameworks, the hook technology inserts hardware-level synchronization events before and after the execution of each computation node, making the devices synchronize to obtain precise forward and backward computation durations. This state data specifically includes the forward computation time (t_{f}), backward computation time (t_{b}), and tensor GPU memory footprint of each node. The structural unit 100 sends the fine-grained static computation graph and the training state information to the model planning unit 200.

After receiving the fine-grained static computation graph and the training state information from the structural unit 100, the model planning unit 200 bisects the fine-grained static computation graph according to its node indices, partitioning the graph into two parts. It applies computation-balanced and memory-balanced partitioning strategies respectively and dynamically determines the shortest computation time for the longest execution stages on both left and right sides through layer-by-layer recursion. The CPU of the host computer transmits the partitioned model to the underlying GPUs via a peripheral component interconnect bus (e.g., PCIe) for deployment.

The model planning unit 200 calculates the computation-balanced partition point ρ_{cb} and the memory-balanced partition point ρ_{mb} based on the fine-grained static computation graph, respectively. Subsequently, the model planning unit 200 enumerates nodes within the closed interval [ρ_{cb}, ρ_{mb}] defined by these two points to calculate the optimal partition point (ρₒₚₜ) that partitions the neural network model into left and right sub-computation graphs. This process is recursively applied to the left and right sub-graphs until the specified target number of stages l is reached. The model planning unit 200 finally passes the partitioned model architecture and stage data to the optimization unit 300, which determines the GPU memory optimization strategy based on the cost model.

The optimization unit 300 receives the model architecture and stage data from the model planning unit 200. The optimization unit 300 is configured to shorten the execution time of each stage, while satisfying the given pipeline parallel partitioning strategy and GPU memory limits. Based on the cost model, the optimization unit 300 calculates idle time and Memory Saving Per Second (MSPS) to evaluate the actual cost of applying memory swapping and recomputation, ultimately selecting the optimization scheme with a lower performance overhead.

Furthermore, the optimization unit 300 integrates cost calculation logic, memory swapping control logic, and recomputation dispatch logic. The cost calculation logic and memory swapping control logic feature a numerical compensation mechanism: in extreme cases where recomputation time approaches zero, a preset constant is introduced for additive compensation to avoid scheduling deadlocks caused by mathematical overflow, thereby ensuring the selection of the synergistic GPU memory optimization scheme with the lowest overall execution time overhead.

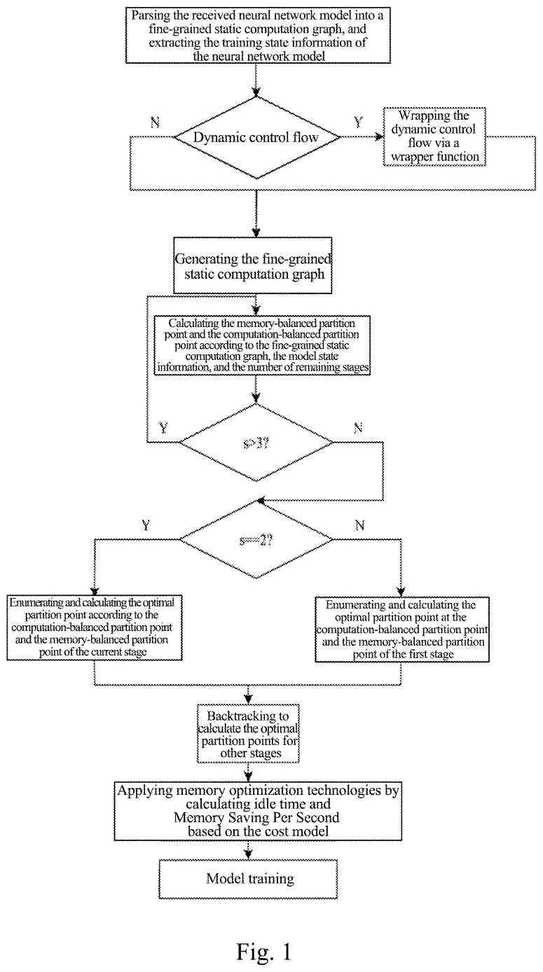

Preferably, the specific steps of the memory-scalable method based on the fine-grained static computation graph executed by the system of the present disclosure are shown in FIG. 1.

Step S100: Parsing the received neural network model into a fine-grained static computation graph and extracting the training state information of the neural network model.

Preferably, the training state information includes the forward computation time, backward computation time, and tensor GPU memory footprint of the nodes.

Preferably, the structural unit 100 parses the neural network model structure into the fine-grained static computation graph based on deep learning compilation technology. Preferably, unlike common layer-based model structures, the fine-grained static computation graph parsed and formed by the present disclosure uses computation nodes as basic units.

Step S110: During the parsing process, the structural unit 100 checks whether the neural network model contains a dynamic control flow. If so, the dynamic control flow is wrapped via a wrapper function to ensure correct construction of the computation graph subsequently.

Preferably, dynamic control flow refers to an execution flow in the neural network model in which different branching decisions are made based on the dimensions of input tensors. For example, when processing a T5 model, the structural unit 100 performs specialized wrapping operations via the wrapper function on different branching decisions made based on tensor dimension information.

For example, the structural unit 100 checks whether the neural network model contains different branching decisions resulting from the dimension information of input tensors.

Step S120: Acquiring state information of the model through hook technology to generate the fine-grained static computation graph.

Preferably, the hook technology can register hook functions in the forward computation function and the backward computation function of the neural network model. When the neural network model executes the forward computation function, the structural unit 100 triggers the registered forward computation hook function to record the forward computation time of the node.

For the backward computation function, when the automatic differentiation system of the computation framework performs backpropagation, the structural unit 100 traverses all tensors in the computation graph and calculates corresponding gradients; a custom hook function is attached to the gradient computation chain of the tensors. The hook function is executed automatically, thereby recording the backward computation time and the tensor GPU memory footprint resulting from the generation or processing of tensors by the nodes during the computation process.

Particularly, for the dynamic control flows wrapped in the preceding steps, the structural unit 100 needs to perform an additional hook function registration operation to ensure the completeness of information acquisition.

Finally, the structural unit 100 acquires the model state information and then populates it into the computation graph node information.

The structural unit 100 fully populates the collected training state information, including forward computation time, backward computation time, and tensor GPU memory footprint, into the node information of the corresponding fine-grained static computation graph, providing an accurate data foundation for subsequent derivation of the optimal partition point ρₒₚₜ.

Step S200: Calculating the memory-balanced partition point and the computation-balanced partition point according to the fine-grained static computation graph, the model state information, and the number of remaining stages.

Step S210: Partitioning the model according to the computation graph parsed from the model, the model state information, and partitioning theorems, and calculating the total computation time Tₓ of the current stage.

Specifically, the formula for calculating the total computation time Tₓ is:

$${T}_{x} = {\sum }_{n ∈ {N}_{x}} ( {t}_{f}^{n} + {t}_{b}^{n} ) .$$

Where Nₓ is the set of nodes in the computation graph, x is the current stage index, t_{f} is the forward computation time, t_{b} is the backward computation time, Tₓ is the total computation time of the current stage, ρ_{cb} is the computation-balanced partition point, and ρ_{mb} is the memory-balanced partition point.

Specifically, the partitioning theorems followed by the model partitioning algorithm are as follows: in the computation scheduling of asynchronous pipeline parallelism (1F1B), earlier stages typically are required to store more activation values and parameter memory, which leads to the computation-balanced partition point ρ_{cb} usually being located to the right of the memory-balanced partition point ρ_{mb} (and vice versa can be proven similarly). When the partition point moves to the right from the computation-balanced partition point ρ_{cb}, more computation nodes are allocated to the first stage. Since both computation time and memory footprint show a monotonically increasing trend and inter-stage communication overhead is negligible, the peak memory footprint and computation time of the first stage increase, while those of the second stage decrease accordingly. Since memory optimization opportunities are uniformly distributed within the model, stages with lower memory footprint will not bear disproportionately high optimization costs merely to meet the GPU memory limit of the computing device. Therefore, regardless of whether memory optimization is applied, the first stage will become the stage with the longest computation time, and its duration will exceed that of the longest stage under computation-balanced partitioning, leading to a decrease in pipeline training performance when the partition point moves to the right. Similarly, if the partition point moves to the left from ρ_{mb}, the second stage will become the longest stage with continuously increasing computation time, and its duration will increase as the partition point moves left.

Preferably, according to the binary recursive model partitioning algorithm, the computation-balanced partition point ρ_{cb} and the memory-balanced partition point ρ_{mb} are obtained in the fine-grained static computation graph based on the partition calculation; the optimal partition point ρₒₚₜ is calculated by enumerating nodes within the closed interval [ρ_{cb}, ρ_{mb}] to partition the model into left and right sub-computation graphs. The process is recursively applied to the left and right sub-computation graphs until the target number of stages l is reached.

First, hierarchical processing is performed, selecting an intermediate stage of the pipeline, treating the left and right intervals as independent stages, and applying computation-balanced and memory-balanced partitioning strategies respectively to dynamically determine the shortest computation time of the longest execution stages on both left and right sides through layer-by-layer recursion. Since the bisection method is used for partitioning, branching decisions are required for cases where the target number of stages is a non-integer power of 2.

Specifically, partitioning starts from the pre-set target number of stages, and there are three possible cases for each partitioning:

Case 1: When the current number of remaining stages s>3, the stage index mid of the current intermediate stage is calculated by the following formula:

$$mid = ⌊ \frac{s}{2} ⌋ .$$

In the above formula, s is the current number of remaining stages.

The computation-balanced partition point ρ_{cb} and the memory-balanced partition point ρ_{mb} of the current stage are calculated, and then the computation nodes of the fine-grained static computation graph are enumerated between the memory-balanced partition point ρ_{mb} and the computation-balanced partition point ρ_{cb} according to the partitioning theorem to find the optimal partition point ρₒₚₜ, completing the partitioning of the current fine-grained static computation graph. Subsequently, recursive partitioning is performed for the two intervals from the starting stage to the intermediate stage (stage index mid) and from the intermediate stage (stage index mid) to the end stage according to the bisection method; that is, these two intervals are respectively partitioned according to the partitioning strategy.

Case 2: If the current number of remaining stages s is not greater than 3, the model planning unit 200 further determines whether s equals 2.

If s=2, nodes are enumerated from smallest to largest within the closed interval [ρ_{cb}, ρ_{mb}] defined by the computation-balanced partition point and the memory-balanced partition point of the current stage. At this time, the constraint condition satisfied by the optimal partition point ρₒₚₜ is:

$${ρ}_{opt} = arg {min}_{1 \leq k \leq n} \vert {\sum }_{i = 1}^{k} {m}_{i} - {M}_{device} \vert .$$

In the above formula, k is the index of the node where the partition point is located, n is the total number of nodes, and M_{device} is the GPU memory limit of the computing device (i.e., the capacity threshold of available GPU memory on a single device); mi is the tensor GPU memory footprint of the node. By verifying whether the partition node of the current partitioning scheme complies with the GPU memory limit of the computing device, it is determined as the optimal partition point ρₒₚₜ if compliant; otherwise, the enumeration continues toward the memory-balanced partition point ρ_{mb} for re-verification.

Case 3: If the current number of remaining stages s≠2 (i.e., the case where s=3), the model planning unit 200 enumerates the computation nodes of the fine-grained static computation graph from smallest to largest starting from the positions of the computation-balanced partition point and the memory-balanced partition point of the stage with the smallest index to determine the optimal partition point ρₒₚₜ.

After the underlying partitioning is completed, the model planning unit 200 backtracks to calculate the optimal partition points for other stages.

Addressing the deficiencies in the existing art such as CN115543639A, which relies on hardware preset grouping and lacks closed-interval enumeration and asymmetric allocation strategies, the model planning unit 200 of the present disclosure performs traversal enumeration of computation nodes based on the physical topological closed interval formed by the computation-balanced partition point and the memory-balanced partition point.

During the binary recursive model partitioning process: if the number of remaining stages is an odd number greater than 3, an asymmetric floor-offset logic toward the left is executed, such that the left sub-computation graph and the right sub-computation graph form an unbalanced mapping based on the remaining odd nodes; if the number of remaining stages is an even number, the graph is partitioned equally according to the position of the topological center node. This logic achieves coverage for any target number of stages (including non-integer power stages), ensuring the continuity of model partitioning.

Step S300: After partitioning is completed, calculating the idle time and Memory Saving Per Second (MSPS) in the pipeline according to the cost model. The optimization unit 300 applies corresponding GPU memory optimization technologies based on these evaluation metrics and finally initiates the model training process.

That is, after completing the model partitioning, the optimization unit 300 shortens the execution time of each stage as much as possible while satisfying the GPU memory limit of the computing device under the given partitioning strategy. A cost model is employed to evaluate the costs of memory swapping and recomputation by calculating idle time and Memory Saving Per Second, thereby selecting a scheme with lower performance overhead.

Specifically, the formula for calculating Memory Saving Per Second (MSPS) in the cost model is as follows:

$$MSPS = \frac{Memory Saving}{Recomputation Time} .$$

In the above formula, Memory Saving is the amount of GPU memory that can be saved by adopting optimization means, and Recomputation Time is the recomputation time for forward computation. To ensure low latency and high accuracy of cost model evaluation, the aforementioned memory saving amount and recomputation time data may be obtained either dynamically by profiling a minimal number of micro-batches in a dry run prior to formal training, or statically extracted from the tensor attributes of nodes retained during the earlier construction of the fine-grained static computation graph.

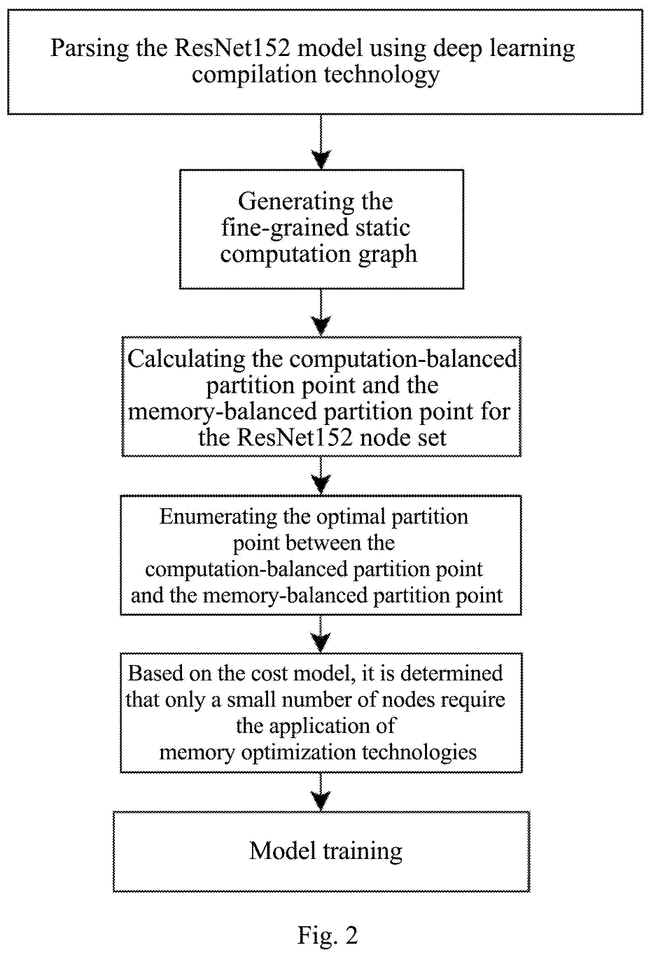

The method of the present disclosure is further illustrated by way of example using the training of a ResNet152 model, as shown in FIG. 2.

Step S131: Parsing the ResNet152 model using deep learning compilation technology.

For the ResNet152 model to be processed, the system first applies deep learning compilation technology to parse the common layer-based model structure into a fine-grained static computation graph with computation nodes as basic units.

Step S132: Generating the fine-grained static computation graph.

Since there is no dynamic control flow in the structure of the ResNet152 model, the fine-grained static computation graph with computation nodes as basic units is generated directly.

Subsequently, the structural unit 100 registers hooks to acquire specific training state information of the neural network model.

The structural unit 100 registers hooks in the forward computation function of the neural network model, such that upon execution of the corresponding operations, the forward computation time of the nodes is recorded. During backpropagation performed by the automatic differentiation system of the computation framework, custom hook functions are attached to the gradient computation chain of the tensors. Through the automatic execution of these hooks, the backward computation time of the node and the tensor GPU memory footprint are acquired, and this key state information is populated into the node information of the computation graph.

Step S133: Calculating the computation-balanced partition point and the memory-balanced partition point for the ResNet152 node set.

In this embodiment, the target number of stages is set to 2. Since the remaining number of stages is exactly 2, the model planning unit 200 determines that it is unnecessary to invoke the complex binary recursive model partitioning algorithm (bisection method) for deep partitioning.

The model planning unit 200 aggregates the information of the node set in the current stage and also performs topological sorting based on the Directed Acyclic Graph (DAG) property of the fine-grained static computation graph. When calculating the total computation time Tₓ of the current stage, if parallel computation branches exist, critical path analysis is applied to identify the branch with the longest duration, whose nodes are included in the calculation, thereby avoiding redundant accumulation of durations from parallel branches. The total computation time is ultimately taken as the sum of the forward computation time tr and the backward computation time ty of all nodes along the critical path of the current stage. The formula for calculating the total computation time Tₓ is as follows:

$${T}_{x} = {\sum }_{n ∈ {N}_{x}} ( {t}_{f}^{n} + {t}_{b}^{n} ) .$$

Where Nₓ is the set of nodes in the computation graph after critical path filtering. Accordingly, the computation-balanced partition point ρ_{cb} and the memory-balanced partition point ρ_{mb} are respectively calculated in the fine-grained computation graph.

The specific formula for calculating the computation-balanced partition point ρ_{cb} is as follows:

$${ρ}_{cb} = arg {min}_{1 \leq k \leq n} \vert {\sum }_{i = 1}^{k} ( {t}_{f}^{i} + {t}_{b}^{i} ) - \frac{{T}_{total}}{2} \vert .$$

In the above formula, k is the index of the node where the partition point is located, n is the total number of nodes, Tₜₒₜₐₗ is the total computation time of the static computation graph,

$${t}_{f}^{i}$$

is the time required tor forward computation starting from the partition point, and

$${t}_{b}^{i}$$

is the time required for backward computation starting from the partition point.

Step S134: Enumerating the optimal partition point between the computation-balanced partition point and the memory-balanced partition point.

According to the characteristics of the 1F1B scheduling strategy under asynchronous pipeline parallelism (APP), earlier stages are required to store more activation values and parameter memory, which leads to the computation-balanced partition point ρ_{cb} usually being located to the right of the memory-balanced partition point ρ_{mb}. The model planning unit 200 enumerates nodes one by one within the closed interval [ρ_{cb}, ρ_{mb}] for evaluation: during the evaluation process, it not only verifies whether the tensor GPU memory footprint resulting from the current partitioning complies with the GPU memory limit of the computing device, but also quantifies the communication overhead incurred by cross-device data transmission; that is, the volume of activation values transmitted when adjacent nodes are partitioned onto different devices is multiplied by the reciprocal of the bandwidth of the underlying hardware interconnect bus, and the resulting value is incorporated as an additional time cost into the aggregate duration.

If the currently enumerated partition scheme satisfies the GPU memory limit of the computing device and yields the minimum aggregate duration, it is identified as the optimal partition point ρₒₚₜ, and the neural network model is formally partitioned into left and right sub-computation graphs. If the limit is not satisfied, the enumeration proceeds toward the memory-balanced partition point ρ_{mb} for re-verification. If no node within the closed interval can satisfy the single-device GPU memory limit after traversing all nodes therein, a memory borrowing strategy is triggered, which marks a portion of inactive tensors at the peak as pending offload to ensure convergence of the partitioning.

To address the resource exhaustion risk and the lack of cost quantification during memory swapping and scheduling found in existing art such as CN114746871A, the present disclosure implements a monitoring and rescheduling mechanism via a multi-level control bus. The underlying data transfer bus transmits the training state information sequence generated by the structural unit 100 to the model planning unit 200. If all candidate partitioning schemes within the closed interval exceed the physical GPU memory limit of a single device, the model planning unit 200 triggers the GPU memory borrowing strategy: it takes over the underlying main memory state via the peripheral component interconnect bus and performs asynchronous data transfer of inactive tensors at peak computation nodes; upon completion of the offloading of inactive tensors to main memory, non-blocking transfer is performed via a Direct Memory Access (DMA) engine, which feeds back and confirms the optimal partitioning scheme.

Step S135: Based on the cost model, it is determined that only a small number of nodes require the application of memory optimization technologies.

After the pipeline-parallel model partitioning is completed, the optimization unit 300 is required to shorten the execution time of each stage as much as possible while satisfying the GPU memory limit of the computing device under the given partitioning strategy. A cost model is introduced at this point to quantitatively evaluate the overhead cost of applying memory swapping and recomputation technologies by precisely calculating the system idle time and Memory Saving Per Second (MSPS). During specific execution, the optimization unit 300 constructs a priority queue based on the MSPS computed for each node, and preferentially issues memory scheduling instructions for inactive tensors with the highest MSPS whose lifetime spans cover the current pipeline idle time. Moreover, the memory swapping technology invokes the DMA engine of the computing device to execute in non-blocking mode, thereby fully concealing the data transfer latency between main memory and GPU memory at the hardware level.

The cost model automatically selects the optimization scheme with the minimum performance overhead based on the cost evaluation results. Since the ResNet152 model itself has a low demand for device GPU memory, the cost model calculation determines that only a minimal number of nodes require the application of these GPU memory optimization technologies.

Step S136: Model training.

Upon completion of all partitioning and optimization strategy deployments, the multi-device distributed training of the model is formally initiated. During model training, the underlying scheduling engine follows the 1F1B scheduling strategy of asynchronous pipeline parallelism; when the computation of a backward propagation node for a single micro-batch is completed, the GPU memory pool management component of the computation framework immediately issues a GPU memory release instruction to asynchronously reclaim the activation value tensors that are no longer needed for that backward propagation node, thereby controlling the peak GPU memory footprint of earlier stages.

### Embodiment 2

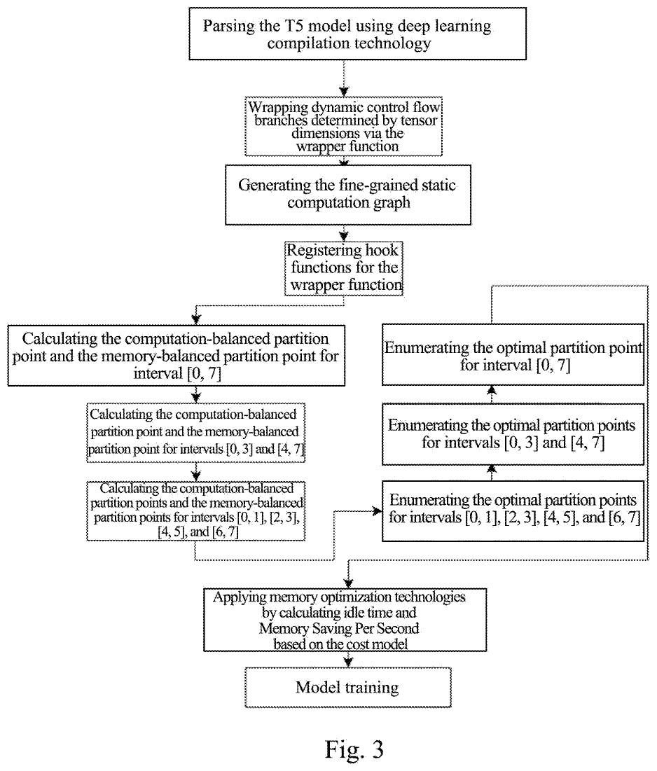

With reference to FIG. 3, taking the training of a T5 model containing dynamic control flow on 8 computing devices (with a target number of stages l set to 8) as an example, the complete pipeline parallel training technical solution of this embodiment is as follows.

Step S141: Parsing the T5 model using deep learning compilation technology.

Step S142: Wrapping dynamic control flow branches determined by tensor dimensions via the wrapper function.

The T5 model generates different branching decisions based on the dimension information of input tensors, meaning it contains dynamic control flow. To ensure the correctness of computation graph generation, additional wrapping of the dynamic control flow branches via the wrapper function is required.

Step S143: Generating the fine-grained static computation graph.

After parsing and wrapping are completed, the structural unit 100 generates a fine-grained static computation graph with computation nodes as basic units.

Step S144: Registering hook functions for the wrapper function.

Hook technology is employed to acquire the training state information of the model. For the wrapping operation performed in step S142, an additional hook function registration operation is required for the wrapped dynamic control flow (wrapper function) at this stage.

Step S145: Calculating the computation-balanced partition point and the memory-balanced partition point for interval [0, 7].

During the model partitioning phase, the computation-balanced partition point ρ_{cb} of the global interval [0, 7] is typically located to the right of the memory-balanced partition point ρ_{mb}. Since the current number of remaining stages satisfies the condition of being greater than 3, the algorithm proceeds to perform further bisection.

Step S146: Calculating the computation-balanced partition point and the memory-balanced partition point for intervals [0, 3] and [4, 7].

After bisection, the computation-balanced partition points ρ_{cb} of the left and right sub-intervals [0, 3] and [4, 7] are typically located to the right of the memory-balanced partition points ρ_{mb}. Both intervals satisfy the condition for further bisection and are processed recursively.

Step S147: Calculating the computation-balanced partition points and the memory-balanced partition points for intervals [0, 1], [2, 3], [4, 5], and [6, 7].

Continuing the bisection, the model planning unit 200 calculates the computation-balanced partition points ρ_{cb} for the bottom-level intervals [0, 1], [2, 3], [4, 5], and [6, 7] respectively, each of which is typically located to the right of the memory-balanced partition point ρ_{mb}. At this point, the number of remaining stages is 2.

Step S148: Enumerating the optimal partition points for intervals [0, 1], [2, 3], [4, 5], and [6, 7].

In the case where the number of remaining stages is 2, the model planning unit 200 computes and enumerates the optimal partition points for intervals [0, 1], [2, 3], [4, 5], and [6, 7] one by one within the corresponding closed intervals defined by the balanced partition points ρₒₚₜ.

For example, when enumerating within a closed interval of a decoder layer, upon detecting that the forward activation value GPU memory footprint exceeds a preset peak threshold, the model planning unit 200 dynamically determines that the current enumeration position cannot satisfy the GPU memory limit of the computing device, and triggers the evaluation pointer to shift node by node toward the memory-balanced partition point ρ_{mb} until a computation node boundary that satisfies the hard GPU memory constraint with low communication compensation is found, which is then designated as the final optimal partition point ρₒₚₜ.

Step S149: Enumerating the optimal partition points for intervals [0, 3] and [4, 7].

After the bottom-level partitioning is completed, the algorithm begins backtracking to sequentially calculate and enumerate the optimal partition points ρₒₚₜ for intervals [0, 3] and [4, 7].

Step S150: Enumerating the optimal partition point for interval [0, 7].

Backtracking continues to the top level to enumerate and determine the optimal partition point ρₒₚₜ for the global interval [0, 7], thereby completing the overall model partitioning with a target number of stages l of 8.

Step S151: Applying memory optimization technologies by calculating idle time and Memory Saving Per Second (MSPS) based on the cost model.

After completing the model partitioning, the execution time of each stage is to be shortened as much as possible while satisfying the GPU memory limit under the given partitioning strategy. The cost model in the optimization unit 300 calculates the idle time and MSPS to evaluate the cost of applying memory swapping and recomputation technologies, thereby selecting the GPU memory optimization scheme with lower performance overhead.

Step S152: Model training.

Upon completion of all partitioning and GPU memory optimization strategy deployments, the distributed training of the T5 model across multiple devices is formally initiated.

First, the effect of the present disclosure on GPU memory optimization during training under limited computing resources was tested. The specific performance metric for measuring the GPU memory optimization effects of different frameworks is the maximum supported single device batch size (i.e., the number of samples per input batch) by training the same model on the same computing devices using different pipeline-parallel training methods; a larger maximum batch size indicates better GPU memory optimization effect.

The validation experiments of the present disclosure were conducted on a server equipped with 8 NVIDIA Tesla A100 GPUs (40 GB GPU memory per device, interconnected via PCIe 4.0 x16). Four state-of-the-art deep learning models were evaluated: the BERT model (340M parameters), the GPT-2 model (770M parameters), the T5 text-to-text transfer Transformer model (780M parameters), and the AmoebaNet model (28M parameters), with performance evaluations performed under 4-stage and 8-stage pipeline configurations. To comprehensively analyze memory efficiency and training performance, four mainstream baseline methods were selected herein for comparison: the Zero Redundancy Optimizer (ZeRO) developed by Microsoft, the PyTorch implementation of GPipe (torchgpipe), the PipeDream method supporting asynchronous pipeline parallelism, and the vPipe system with dynamic memory optimization capability.

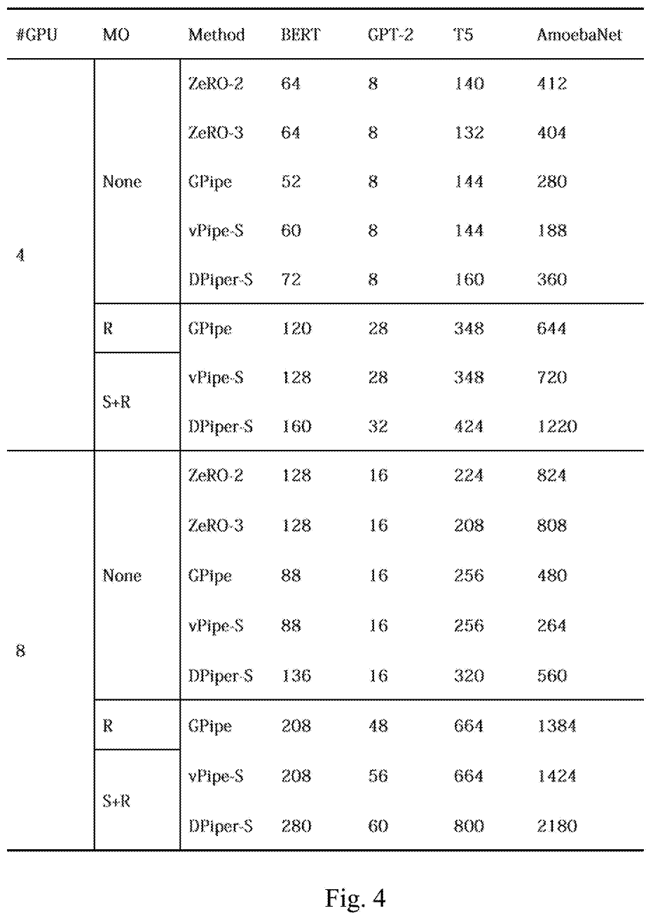

To evaluate the GPU memory efficiency of each method, synchronous pipeline-parallel training experiments were conducted in the present disclosure. As shown in the experimental results in FIG. 4, the column header #GPU denotes the number of computing nodes/stages; MO denotes the Memory Optimization strategy, where None indicates no optimization is enabled, R indicates that only Recomputation is enabled, and S+R indicates that both memory Swapping and Recomputation are enabled simultaneously. The methods of vPipe and the present disclosure are labeled as vPipe-S and DPiper-S, respectively. The experimental results shown in FIG. 4 indicate that:

(1) For already-existing methods, ZeRO-2 and ZeRO-3 achieve almost the same maximum batch sizes across all four models. For Transformer-based models such as BERT, GPT-2, and T5, the maximum batch sizes of GPipe and vPipe are basically comparable to those of ZeRO.

(2) On the more heterogeneously structured AmoebaNet model, the batch sizes of GPipe and vPipe are significantly smaller than those of ZeRO—when the number of pipeline stages is 4, they reach only 68% and 46% of ZeRO's batch size, respectively, and further decline to 58% and 32% when the number of stages increases to 8. This discrepancy stems from the inability of existing frameworks to adequately handle the mismatch between computation time and memory footprint in CNN models. Furthermore, GPipe supports larger batch sizes than vPipe under the default configuration, but this relationship reverses upon enabling memory optimization, further demonstrating that naive memory optimization, due to the lack of fine-grained control, shifts the GPU memory bottleneck stage within existing frameworks.

(3) The experimental data shown in FIG. 4 demonstrate the significant technical advantages of the present disclosure (DPiper-S): under identical hardware conditions, the maximum batch size of the present disclosure comprehensively surpasses all baseline schemes, whether in the default configuration or with maximum memory optimization enabled. For example, in the stress test with 8 stages and both memory swapping and recomputation enabled (S+R), the present disclosure achieves a maximum batch size of 800 on the T5 model (significantly outperforming vPipe-S's 664) and 2180 on the AmoebaNet model (exceeding vPipe-S's 1424). This demonstrates that the automated joint optimization mechanism of the present disclosure, based on fine-grained computation graphs and the cost model, effectively overcomes local stage GPU memory bottlenecks and achieves favorable memory scalability.

While improving memory scalability, the present disclosure also maintains pipeline training throughput. Training performance is evaluated through an experimental testing framework, where the duration and data volume per training iteration are recorded via instrumentation during training; the performance metric is throughput in pipeline training, expressed in samples per second, where higher throughput indicates greater training speed of the pipeline parallel framework.

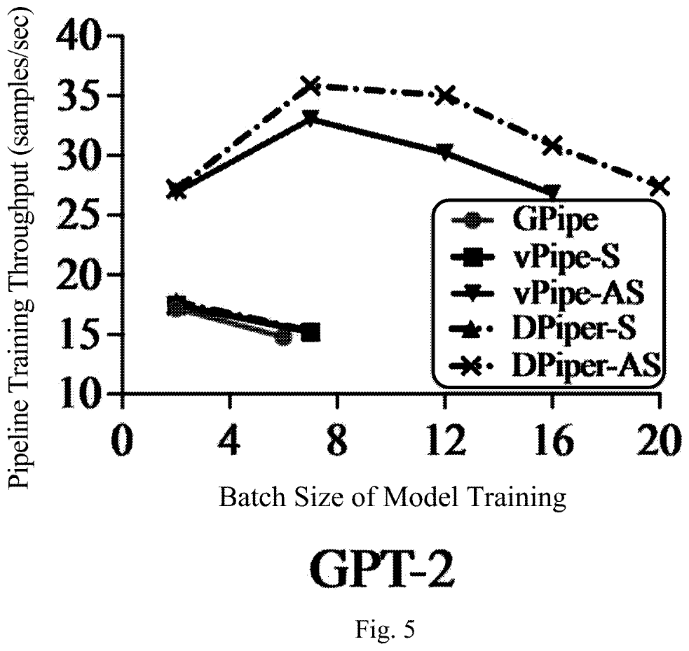

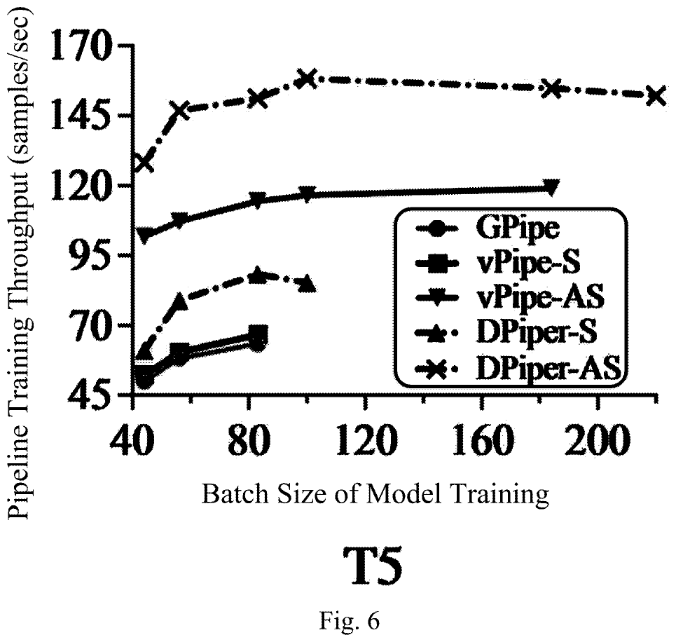

FIG. 5 and FIG. 6 are comparison curves of training throughput experimental results between the method provided by the present disclosure and existing baseline technologies on the GPT-2 model and the T5 model, respectively. In both figures, the horizontal axis represents the batch size of model training, and the vertical axis represents the pipeline training throughput in samples per second. For ease of comparison, curves with the suffix -S in the legend (e.g., vPipe-S, DPiper-S) represent test results using Synchronous Pipeline Parallelism (SPP) mode; curves with the suffix -AS (e.g., vPipe-AS, DPiper-AS) represent test results using Asynchronous Pipeline Parallelism (APP) mode. The DPiper series curves represent the actual test results of applying the memory-scalable system and method based on fine-grained static computation graphs of the present disclosure.

FIG. 5 intuitively illustrates the performance of each technical solution on the GPT-2 model. Under synchronous pipeline mode, the throughput curves of the present disclosure (DPiper-S), GPipe, and vPipe-S are highly overlapping. The fundamental reason is that the computation time and memory footprint ratios of various layers in the GPT-2 model are highly consistent, causing the computation-balanced partition point and the memory-balanced partition point to basically coincide, which objectively limits the further optimization space of the fine-grained partitioning strategy. However, under asynchronous pipeline mode, as the batch size gradually increases, the advantage of the present disclosure (DPiper-AS) begins to emerge. The training throughput curve of the present disclosure consistently remains above that of vPipe-AS. When the batch size reaches the optimal execution range, the training speed of the present disclosure reaches an average of 1.15 times that of the vPipe method, effectively improving overall computation efficiency.

FIG. 6 illustrates the performance of each technical solution on the T5 model. Significantly different from the GPT-2 model, the T5 model adopts a more complex encoder-decoder hybrid architecture. This highly heterogeneous structure results in significant variation in memory consumption across different computation layers, for which the fine-grained static computation graph partitioning method of the present disclosure provides optimization space. In the comparison of the asynchronous pipeline mode, it can be clearly observed that: as the model training batch size continues to scale up, the throughput of the existing method vPipe-AS tends to saturate and encounters a bottleneck after reaching approximately 120 samples/sec; whereas the throughput of the present disclosure (DPiper-AS) is significantly improved, maintaining a high level of approximately 150 samples/sec at larger batch sizes, with the training speed increased by up to 1.34 times compared to the existing technology. Furthermore, the experimental data in FIG. 4 further indicate that when the number of pipeline stages scales to a larger size (e.g., 8 stages), the throughput performance of the present disclosure remains stable without significant performance degradation, demonstrating favorable memory scalability and concurrent computational capability under GPU memory limits.

### Embodiment 3

This embodiment is a further description of Embodiment 1 or Embodiment 2.

Preferably, this embodiment further discloses the physical entity structure of the system.

Preferably, the underlying physical entities of the system of the present disclosure include a host computer and an underlying computing device cluster (e.g., multiple GPUs equipped with independent VRAM). To achieve efficient data flow and overcome the latency of pure software execution, the structural unit 100, the model planning unit 200, and the optimization unit 300 are specifically configured as dedicated hardware circuits constructed from application-specific integrated circuits (ASICs) or programmable logic arrays.

Specifically, the structural circuit, the model planning circuit, and the optimization circuit are hardware devices constructed using dedicated processing circuits hardwired in ASICS, Field-Programmable Gate Arrays (FPGAs), or Systems-on-Chip (SoCs). They comprise fixed logic gate arrays dedicated to performing fine-grained static computation graph parsing, optimal partition point enumeration, and overhead cost evaluation.

As hardware, the structural circuit, the model planning circuit, and the optimization circuit are electrically connected to each other via on-chip high-speed hardware interconnect buses (e.g., AMBA AXI bus) or direct pin connections to achieve high-bandwidth, low-latency hardware-level data interaction.

The hardware output pins of the structural circuit are electrically connected to the hardware input pins of the model planning circuit to directly transmit the generated fine-grained static computation graph and training state information. The hardware output pins of the model planning circuit are electrically connected to the hardware input pins of the optimization circuit to directly send the partitioned sub-computation graphs and stage data.

The circuit board (or host chipset) on which the above three hardware entity circuits are located is electrically connected to the underlying multiple GPUs via a peripheral component interconnect bus (e.g., a PCIe 4.0 x16 data bus), thereby directly issuing instructions and GPU memory optimization schemes to the GPUs.

The memory-scalable system based on fine-grained static computation graphs of the present disclosure comprises a structural circuit, a model planning circuit, and an optimization circuit that are communicatively connected to one another via a hardware bus. The structural circuit is configured as a dedicated hardware circuit constructed from ASICs or programmable logic arrays, and is configured to parse the structure of a neural network model into a fine-grained static computation graph with computation nodes as basic units, and to acquire training state information of the neural network model.

The model planning circuit is configured as a dedicated hardware circuit constructed from ASICs or programmable logic arrays, and is configured to calculate the computation-balanced partition point and the memory-balanced partition point of stage nodes based on the fine-grained static computation graph and the training state information, enumerate computation nodes within the closed interval defined by the computation-balanced partition point and the memory-balanced partition point, determine the optimal partition point to partition the neural network model into left and right sub-computation graphs, and process recursively until the target number of stages is reached.

The optimization circuit is configured as a dedicated hardware circuit constructed from ASICs or programmable logic arrays, and is configured to evaluate the overhead cost of applying memory swapping and recomputation technologies based on the cost model after model partitioning is completed, so as to select the GPU memory optimization scheme.

The step performed by the structural circuit to parse the structure of the neural network model into a fine-grained static computation graph with computation nodes as basic units includes: parsing the structure of the neural network model into a fine-grained static computation graph based on deep learning compilation technology; and if the neural network model contains a dynamic control flow, additionally wrapping the dynamic control flow via a wrapper function to construct the fine-grained static computation graph.

The step performed by the structural circuit to obtain the training state information of the neural network model includes: registering customized functions in the forward computation function and the backward computation function of the neural network model, respectively, using hook technology, so as to obtain training state information including forward computation time, backward computation time, and tensor GPU memory footprint of the computation nodes.

The step performed by the model planning circuit to calculate the computation-balanced partition point and the memory-balanced partition point for stage nodes includes: calculating the total computation time of the current pipeline stage, and subsequently deriving the computation-balanced partition point based on the computation time consumption of the stage nodes, and deriving the memory-balanced partition point based on the GPU memory consumption of the stage nodes; wherein the total computation time is the sum of the forward computation times and the backward computation times of all nodes within the computation node set of the current stage.

The step performed by the model planning circuit to process until the target number of stages is reached specifically includes: selecting an intermediate stage of a pipeline, and treating left and right intervals as independent stages to perform recursive processing layer by layer; when the current number of remaining stages is greater than 3, continuing to perform bisection processing on an interval from a leftmost or rightmost computing device to the intermediate stage; when the current number of remaining stages is equal to 3, executing traversal starting from the computation-balanced partition point and the memory-balanced partition point of the first stage to derive an optimal partition point through enumeration; and when the current number of remaining stages is equal to 2, performing an enumeration search within a closed interval defined by the computation-balanced partition point and the memory-balanced partition point to determine an optimal partition point for partitioning the model into left and right sub-computation graphs.

The step performed by the model planning circuit to enumerate computation nodes within the closed interval defined by the computation-balanced partition point and the memory-balanced partition point to determine the optimal partition point includes: enumerating partitioning schemes one by one within the closed interval and verifying whether each scheme complies with the GPU memory limit of the computing device; if a currently enumerated partitioning scheme complies with the GPU memory limit, determining it as the optimal partition point; and if not, moving toward the memory-balanced partition point and re-performing the verification.

The step performed by the optimization circuit to evaluate overhead costs of applying memory swapping and recomputation technologies based on a cost model to select a GPU memory optimization scheme includes: calculating idle time and Memory Saving Per Second (MSPS) based on the cost model to quantitatively evaluate the overhead costs of adopting the memory swapping and recomputation technologies, such that under a premise of satisfying the GPU memory limit of computing devices for a given partitioning strategy, a GPU memory optimization scheme with minimum performance overhead is selected to shorten stage execution time.

It should be noted that the above-mentioned embodiments are exemplary. Those skilled in the art, inspired by the present disclosure, may devise various solutions within the scope and protection of the present disclosure. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, with terms like “preferably”, “according to a preferred embodiment”, or “optionally” indicating distinct concepts in respective paragraphs. The applicant reserves the right to file divisional applications for each inventive concept.

What is claimed is:

1. A memory-scalable system based on fine-grained static computation graphs, the system comprising:
a structural unit, configured to parse a structure of a neural network model into a fine-grained static computation graph with computation nodes as basic units, and obtain training state information of the neural network model;
a model planning unit, configured to calculate a computation-balanced partition point and a memory-balanced partition point for stage nodes based on the fine-grained static computation graph and the training state information, enumerate computation nodes within a closed interval defined by the computation-balanced partition point and the memory-balanced partition point to determine an optimal partition point for partitioning the neural network model into left and right sub-computation graphs, and process until a target number of stages is reached; and
an optimization unit, configured to evaluate overhead costs of applying memory swapping and recomputation technologies based on a cost model after model partitioning is completed, so as to select a GPU memory optimization scheme.

2. The system according to claim 1, wherein the step performed by the structural unit to parse the structure of the neural network model into the fine-grained static computation graph with the computation nodes as basic units comprises:
parsing the structure of the neural network model into the fine-grained static computation graph based on deep learning compilation technology; and
if the neural network model contains a dynamic control flow, additionally wrapping the dynamic control flow via a wrapper function to construct the fine-grained static computation graph.

3. The system according to claim 1, wherein the step performed by the structural unit to obtain the training state information of the neural network model comprises:
registering customized functions in a forward computation function and a backward computation function of the neural network model, respectively, using hook technology, so as to obtain the training state information including a forward computation time, a backward computation time, and a tensor GPU memory footprint of the computation nodes.

4. The system according to claim 1, wherein the step performed by the model planning unit to calculate the computation-balanced partition point and the memory-balanced partition point for the stage nodes comprises:
calculating a total computation time of a current pipeline stage, and subsequently deriving the computation-balanced partition point based on a computation time consumption of the stage nodes, and deriving the memory-balanced partition point based on a GPU memory consumption of the stage nodes;
wherein the total computation time is a sum of forward computation times and backward computation times of all nodes within a computation node set of the current stage.

5. The system according to claim 1, wherein the step performed by the model planning unit to process until the target number of stages is reached specifically comprises:
selecting an intermediate stage of a pipeline, and treating left and right intervals as independent stages to perform recursive processing layer by layer;
when a current number of remaining stages is greater than 3, continuing to perform bisection processing on an interval from a leftmost or rightmost computing device to the intermediate stage;
when the current number of remaining stages is equal to 3, executing traversal starting from the computation-balanced partition point and the memory-balanced partition point of a first stage to derive the optimal partition point through enumeration; and
when the current number of remaining stages is equal to 2, performing an enumeration search within a closed interval defined by the computation-balanced partition point and the memory-balanced partition point to determine the optimal partition point for partitioning the model into the left and right sub-computation graphs.

6. The system according to claim 1, wherein the step performed by the model planning unit to enumerate the computation nodes within the closed interval defined by the computation-balanced partition point and the memory-balanced partition point to determine the optimal partition point comprises:
enumerating partitioning schemes one by one within the closed interval and verifying whether each scheme complies with a GPU memory limit of a computing device;
if a currently enumerated partitioning scheme complies with the GPU memory limit, determining it as the optimal partition point; and
if not, moving toward the memory-balanced partition point and re-performing the verification.

7. The system according to claim 1, wherein the step performed by the optimization unit to evaluate the overhead costs of applying the memory swapping and recomputation technologies based on the cost model to select the GPU memory optimization scheme comprises:
calculating idle time and Memory Saving Per Second based on the cost model to quantitatively evaluate the overhead costs of adopting the memory swapping and the recomputation technologies, such that while satisfying a GPU memory limit of computing devices under a given partitioning strategy, the GPU memory optimization scheme with minimum performance overhead is selected to shorten stage execution time.

8. The system according to claim 1, wherein when all candidate partitioning schemes within the closed interval exceed a physical GPU memory limit of computing devices, the model planning unit triggers a GPU memory borrowing strategy to manage a main memory state via an interconnect bus, and performs asynchronous data transfer of inactive tensors at peak computation nodes to offload them to a main memory.

9. The system according to claim 7, wherein the optimization unit internally integrates cost calculation logic, memory swapping control logic, and recomputation dispatch logic; and
the optimization unit is configured to construct a priority queue based on Memory Saving Per Second calculated for each node, preferentially issue memory scheduling instructions for inactive tensors with the highest Memory Saving Per Second whose lifecycle span covers current pipeline idle time, and invoke a Direct Memory Access (DMA) engine to execute memory swapping in a non-blocking mode.

10. A memory-scalable method based on fine-grained static computation graphs, the method comprising:
parsing a structure of a neural network model into a fine-grained static computation graph with computation nodes as basic units, and obtaining training state information of the neural network model;
calculating a computation-balanced partition point and a memory-balanced partition point for stage nodes based on the fine-grained static computation graph and the training state information, enumerating computation nodes within a closed interval defined by the computation-balanced partition point and the memory-balanced partition point to determine an optimal partition point for partitioning the neural network model into left and right sub-computation graphs, and processing until a target number of stages is reached; and
evaluating overhead costs of applying memory swapping and recomputation technologies based on a cost model after model partitioning is completed, so as to select a GPU memory optimization scheme.

11. The method according to claim 10, wherein the step of calculating the computation-balanced partition point and the memory-balanced partition point for the stage nodes comprises:
calculating a total computation time of a current pipeline stage, and subsequently deriving the computation-balanced partition point based on a computation time consumption of the stage nodes, and deriving the memory-balanced partition point based on a GPU memory consumption of the stage nodes;
wherein the total computation time is a sum of forward computation times and backward computation times of all nodes within a computation node set of the current stage.

12. The method according to claim 10, wherein the step of parsing the structure of the neural network model into the fine-grained static computation graph with the computation nodes as basic units comprises:
parsing the structure of the neural network model into the fine-grained static computation graph based on deep learning compilation technology; and
if the neural network model contains a dynamic control flow, additionally wrapping the dynamic control flow via a wrapper function to construct the fine-grained static computation graph.

13. The method according to claim 10, wherein the step of obtaining the training state information of the neural network model comprises:
registering customized functions in a forward computation function and a backward computation function of the neural network model, respectively, using hook technology, so as to obtain the training state information including a forward computation time, a backward computation time, and a tensor GPU memory footprint of the computation nodes.

14. The method according to claim 10, wherein the step of determining the optimal partition point to partition the neural network model into the left and right sub-computation graphs, and processing until the target number of stages is reached comprises:
selecting an intermediate stage of a pipeline, and treating left and right intervals as independent stages to perform recursive processing layer by layer;
when a current number of remaining stages is greater than 3, continuing to perform bisection processing on an interval from a leftmost or rightmost computing device to the intermediate stage;
when the current number of remaining stages is equal to 3, executing traversal starting from the computation-balanced partition point and the memory-balanced partition point of a first stage to derive the optimal partition point through enumeration; and
when the current number of remaining stages is equal to 2, performing an enumeration search within a closed interval defined by the computation-balanced partition point and the memory-balanced partition point to determine the optimal partition point for partitioning the model into the left and right sub-computation graphs.

15. The method according to claim 10, wherein the step of enumerating the computation nodes within the closed interval defined by the computation-balanced partition point and the memory-balanced partition point to determine the optimal partition point comprises:
enumerating partitioning schemes one by one within the closed interval and verifying whether each scheme complies with a GPU memory limit of a computing device;
if a currently enumerated partitioning scheme complies with the GPU memory limit, determining it as the optimal partition point; and
if not, moving toward the memory-balanced partition point and re-performing the verification.

16. The method according to claim 10, wherein the step of evaluating the overhead costs of applying the memory swapping and recomputation technologies based on the cost model to select the GPU memory optimization scheme comprises:
calculating idle time and Memory Saving Per Second based on the cost model to quantitatively evaluate the overhead costs of adopting the memory swapping and the recomputation technologies, such that while satisfying a GPU memory limit of computing devices under a given partitioning strategy, the GPU memory optimization scheme with minimum performance overhead is selected to shorten stage execution time.

17. A memory-scalable hardware device based on fine-grained static computation graphs, comprising: a structural circuit, a model planning circuit, and an optimization circuit that are communicatively connected to one another via an on-chip high-speed hardware interconnect bus;
wherein the structural circuit, the model planning circuit, and the optimization circuit are all configured as dedicated processing circuits, and wherein:
the structural circuit is configured to parse a structure of a neural network model into a fine-grained static computation graph with computation nodes as basic units, and obtain training state information of the neural network model;
the model planning circuit is configured to calculate a computation-balanced partition point and a memory-balanced partition point for stage nodes based on the fine-grained static computation graph and the training state information, enumerate computation nodes within a closed interval defined by the computation-balanced partition point and the memory-balanced partition point to determine an optimal partition point for partitioning the neural network model into left and right sub-computation graphs, and process until a target number of stages is reached; and
the optimization circuit is configured to evaluate overhead costs of applying memory swapping and recomputation technologies based on a cost model after model partitioning is completed, so as to select a GPU memory optimization scheme.

18. A storage medium having a computer program stored thereon that, when executed by a processor, causes the processor to perform the steps of the method of claim 10.

19. An electronic device, comprising a memory and a processor, wherein the memory has a computer program stored thereon that, when executed by the processor, causes the processor to perform the steps of the method of claim 10.

20. The electronic device according to claim 19, wherein the electronic device is a host computer, and the processor is communicatively connected to a plurality of computing devices via a peripheral component interconnect bus to transmit the partitioned sub-computation graphs and the GPU memory optimization scheme to the computing devices for deployment and training.
